(19) United States
(12) Patent Application Publication
(10) Pub. No.: US 2015/0369423 A1
(43) Pub. Date: Dec. 24, 2015

(54) ADVERTISING STAND DEVICE

(71) Applicant: CAP, St Ferreol (FR)

(72) Inventor: Jean-Pierre CHEVALLOT, La Tronche (FR)

(21) Appl. No.: 14/410,333

(22) PCT Filed: May 17, 2013
(86) PCT No.: PCT/FR2013/051093

§ 371 Date: Dec. 22, 2014

(30) Foreign Application Priority Data
Jun. 21, 2012 (FR) 12/55824

(51) Int. Cl. F16M 13/02; G09F 23/00; F16M 11/00

(52) U.S. Cl. CPC F16M 13/022; F16M 11/00; G09F 23/00; G09F 2023/0025

(57) ABSTRACT

The invention relates to an advertising stand device (2) for representing a substantially cylindrical object comprising: a frame (4) including a pillar (8) and an at least partially upwardly arched bracket; and a shell (6) suitable for being fitted onto the frame (4), the shell (6) including: an upper edge (14) that is at least partially upwardly arched in order to cover the bracket; at least one at least partially downwardly arched lower edge (16) opposite the upper edge (14); first and second side edges (18, 20); and at least one advertising stand surface (22) having a pattern, said pattern representing a line (26) at least partially arched downward and extending the ends of the upper edge (14), or a line at least partially arched upward and extending the ends of the lower edge.

### TECHNICAL FIELD

The present invention relates to an advertising medium device for the representation of a substantially cylindrical object, such as a can, a tin or a bottle.

### BACKGROUND

It is known from the state of the art an advertising medium device including:
a frame comprising two hoops and a mast vertically erected within the two hoops, the two hoops being suspended to the mast by turnbuckles; and
a tubular sail, exhibiting at its upper and lower edges two annular sheaths, within which the two hoops are engaged.

Such a device is advantageous in that it allows a three-dimensional representation of a substantially cylindrical object to the public.

However, this device exhibits a high wind factor. Also, when it is installed outdoors, for example on a beach, the device can be blown away by the wind, or the sail may tear apart.

Moreover, the device exhibits an imposing overall dimension which makes its use unsuitable indoors, in particular on a confined exhibition stand.

Finally, assembling, and alternately disassembling the device take a long time and are tedious to implement.

Also known from the state of the art is an advertising medium device including:
a frame comprising a mast and a rectilinear bracket mounted on the mast; and
a rectangular sail exhibiting, on an upper edge and a lateral edge, sheaths adapted to be engaged respectively on the bracket and on the mast.

The sail comprises a pattern representing the can or the tin in perspective.

When the device is installed outdoors, it is sufficient to orient the device so that the wind direction is parallel to the sail so that the wind resistance is minimized. Moreover, assembling, and alternately disassembling, the device is simplified.

The disadvantage of such a device remains however in that the public perceives clearly that the can or the tin is represented in a two-dimensional way. Also, the appeal that a three-dimensional device can generate to the public is lost.

### BRIEF SUMMARY

The invention aims to overcome this last disadvantage.

The invention relates to an advertising medium device for the representation of a substantially cylindrical object, such as a can, a tin or a bottle, characterized in that it includes:
a frame comprising a mast and a bracket at least partially arched upwards mounted on the mast; and
a sail adapted to be engaged on the frame, the sail comprising:
   an upper edge arched upwards provided for covering the bracket,
   at least one lower edge at least partially arched downwards, opposite to the upper edge;
   first and second lateral edges connecting the upper and lower edges, the first lateral edge being provided for covering the mast; and
   at least one advertising medium face exhibiting a pattern, this pattern featuring a line at least partially arched downwards extending the ends of the upper edge or a line at least partially arched upwards extending the ends of the lower edge.

The edges of the sail delimit the outline of the substantially cylindrical object viewed in perspective. The entire sail, and no more only a pattern present on this sail, materializes the object.

The sail of the device according to the invention allows enhancing the illusion of a three-dimensional representation of the object.

This illusion is obtained by the combination of structural characteristics, namely the presence of an arched bracket, of a sail the upper and lower edges of which are arched, and of the pattern present on the face of the advertising medium featuring an arched line.

When the pattern features a line arched downwards extending the ends of the upper edge, the illusion is that the object is viewed from above.

When the pattern figures a line arched upwards extending the ends of the lower edge, the illusion is that the object is viewed from below.

It should be understood that the pattern featuring the arched line does not constitute in any case advertising information, but constitutes a structural characteristic contributing to the illusion of a three-dimensional representation of the object.

The bracket, when rigid, and the mast, allow stretching the sail.

The device exhibits a low wind factor. The device exhibits a reduced overall dimension which makes its use perfectly suitable on an exhibition stand. Finally, assembling, and alternately disassembling the device remains simple and fast.

The device according to the invention may include one or more of the following characteristics.

According to one characteristic, the lateral edges of the sail are rectilinear.

According to another characteristic, the curvature radii of the bracket, of the upper edge of the sail, and of the pattern featuring the line, are identical. Thus, the illusion of a three-dimensional representation of the object is enhanced still further.

According to another characteristic, the curvature radii of the bracket, of the upper edge of the sail, and of the pattern featuring the line, may be distinct. According to one embodiment, the bracket is removably mounted on the mast.

Under these conditions, the overall dimension of the device when it is disassembled is minimized.

For example, the mast and/or the bracket are tubular, and the mast and the bracket are press-fitted together.

Advantageously, the bracket comprises articulation means connecting first and second segments of the bracket, allowing a deformation of the bracket between:
a non-use position in which the bracket segments extend substantially in a parallel manner; and
a use position in which the bracket segments extend substantially in a perpendicular manner.

For example, the articulation means comprise a ball joint connecting the first and second bracket segments.

In a preferred embodiment, the sail forms a cover exhibiting:
an upper edge arched upwards provided for covering the bracket;
two lower edges arched downwards, opposite to the upper edge;
first and second lateral edges connecting the upper and lower edges, the first lateral edge being provided for covering the mast;
two advertising medium faces at least one of which exhibits a pattern, this pattern featuring a line at least partially arched downwards extending the ends of the upper edge, or a line at least partially arched upwards extending the ends of one of the lower edges;

and the sail delimits between the advertising medium faces an open volume, within which the frame can be engaged.

Under these conditions, the sail is engaged on the frame in a slipcover or a sock like manner.

Preferably, the device comprises means for stretching the sail on the frame.

For example, the means for stretching the sail on the frame comprise:
a pin mounted on the mast, extending transversely to the mast; and
a strap linked to the sail likely to be attached to the pin.

Advantageously, the strap exhibits two strap portions fixed to the sail and the free ends of which are equipped with complementary fixing means, such as pieces of hook and loop fabrics.

According to one characteristic, the device includes an element fitted on the sail or on the bracket, featuring an accessory of the substantially cylindrical object, such as a straw or a handle.

In one embodiment, the device includes a string of characters, for example a brand, extending along a guiding line, this guiding line is arched downwards or upwards.

Preferably, the guiding line has the same curvature as the lower edge of the sail.

Advantageously, the characters of the string of characters are dimensioned in such a way that the size of the characters decreases going from the center of the string of characters toward the ends of the string of characters.

According to one characteristic, the at least one advertising medium face exhibits at least one area arched upwards or downwards featuring a shade.

Thus, the illusion of a three-dimensional view of the object is enhanced.

According to another characteristic, the mast exhibits a recess, so as to fit the shape of a bottle or a can neck.

The invention also relates to a method for manufacturing an advertising medium device for the representation of a substantially cylindrical object, such as a can, a tin or a bottle, characterized in that it includes the following steps:
provide a frame comprising a mast and a bracket at least partially arched upwards adapted to be mounted on the mast;
provide a sail adapted to be engaged on the frame, the sail comprising:
   an upper edge at least partially arched upwards provided for covering the bracket;
   at least one lower edge at least partially arched downwards, opposite to the upper edge;
   first and second lateral edges connecting the upper and lower edges, the first lateral edge being provided for covering the mast; and
   at least one advertising medium face;
carry out, on said at least one advertising medium face, a pattern featuring a line at least partially arched downwards extending the ends of the upper edge, or a line at least partially arched upwards extending the ends of one of the lower edges.

### BRIEF DESCRIPTION OF THE DRAWINGS

The invention will be better understood using the following description with reference to the appended schematic drawing representing, by way of non-limitative example, five embodiments of an advertising medium device for the representation of a substantially cylindrical object according to the invention.

FIG. 1 is a front view of a first advertising medium device for the representation of a can, the cap of which is closed;

FIG. 2 is a cross-sectional view along a plane II-II of the device of FIG. 1;

FIG. 3 is a longitudinal sectional view along a plane III-Ill of the device of FIG. 1;

FIG. 4 is a front view of a frame equipping the device of FIGS. 1 to 3, in the mounted configuration;

FIG. 5 is a front view of a first embodiment of a bracket equipping the frame of FIG. 4, in the disassembled configuration;

FIG. 6 is a front view of a second embodiment of a bracket equipping the frame of FIG. 4, in the non-use position;

FIG. 7 is a front view of the bracket of FIG. 6, in the use position;

FIG. 8 is a front view of a second advertising medium device for the representation of a glass comprising an ice cube;

FIG. 9 is a front view of a third advertising medium device for the representation of a glass comprising a straw and a slice of lemon;

FIG. 10 is a front view of a fourth advertising medium device for the representation of a beer mug;

FIG. 11 is a front view of a fifth advertising medium device for the representation of a can, the cap of which is open;

FIG. 12 is a front view of a sixth advertising medium device for the representation of a bottle; and

FIG. 13 is a longitudinal sectional view along a plane III-III of the device of FIG. 12

### DETAILED DESCRIPTION

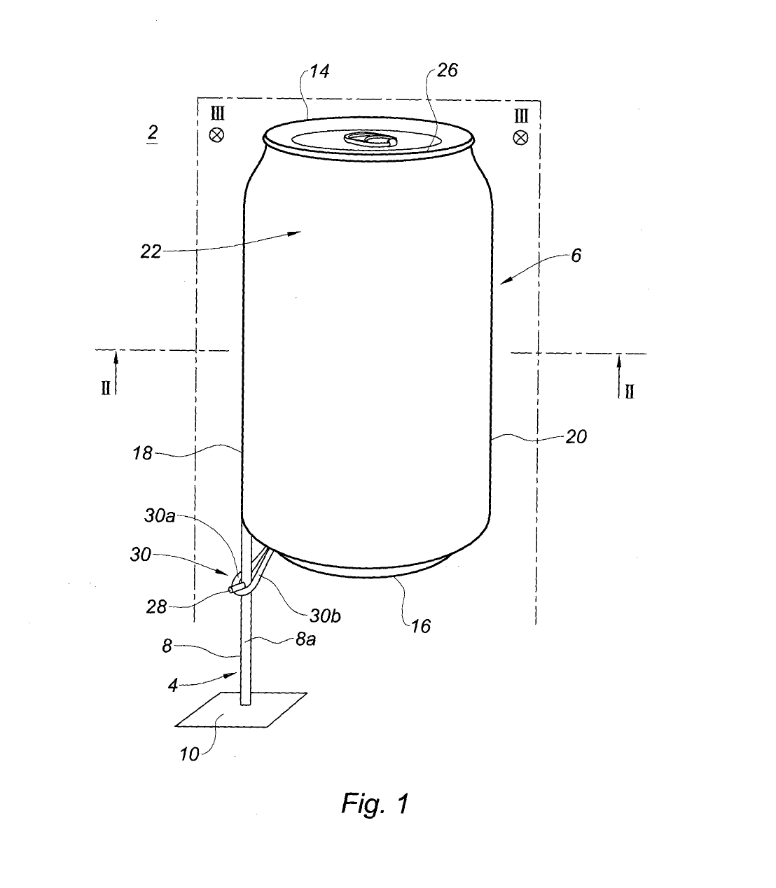

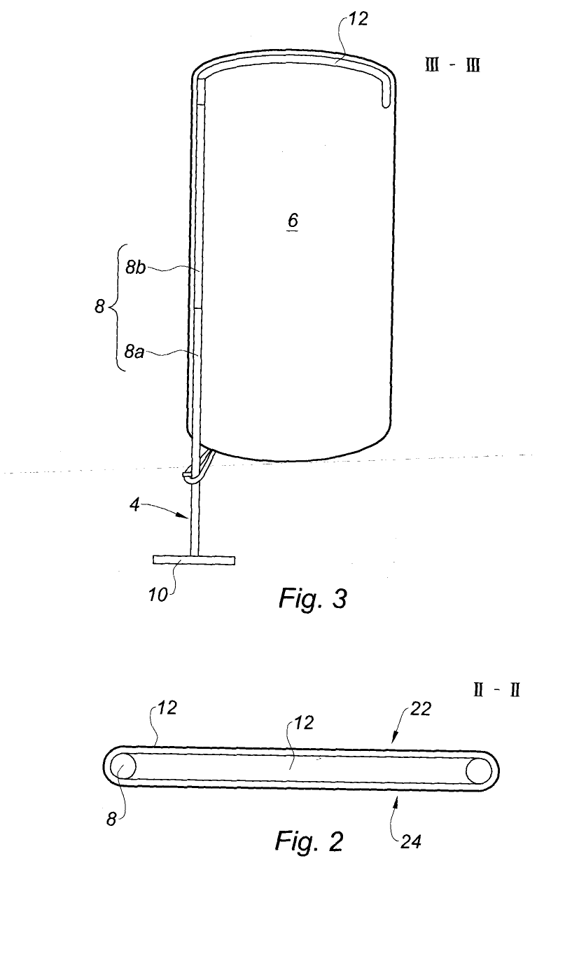

FIGS. 1 to 3 represent an advertising medium device 2 for the representation of a can. This device 2 includes a frame 4 and a sail 6 engaged on the frame 4.

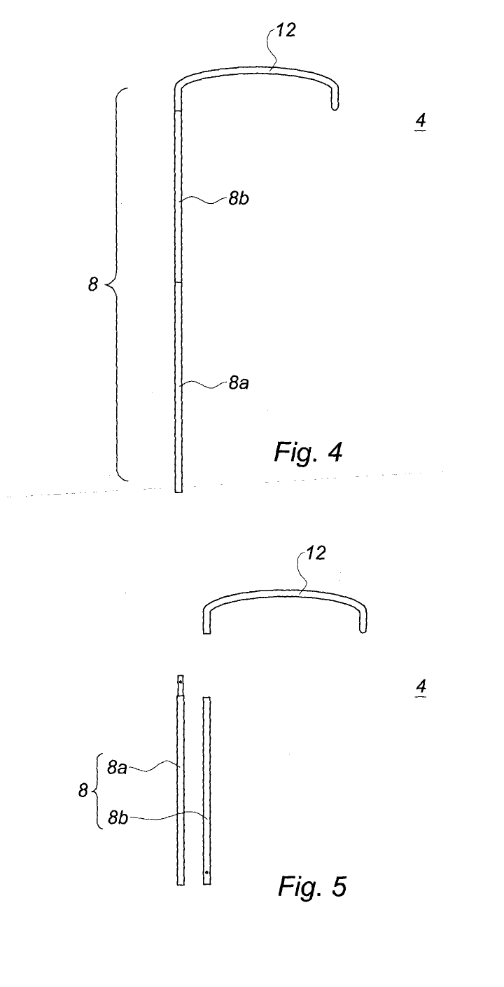

The frame 4 (represented in FIGS. 4 and 5) comprises a mast 8 erected vertically. This mast 8 exhibits tubular lower 8a and upper 8b mast segments. Lower 8a and upper 8b mast segments are press-fitted together. The lower mast segment 8a rests on a preferably ballasted foot 10.

The frame 4 also comprises a bracket 12 removably mounted on the mast 8. To this end, the bracket 12 is tubular and is press-fitted on the upper mast segment 8b. The bracket 12 is arched upwards.

The sail 6 forms a cover exhibiting:
an upper edge 14 arched upwards provided for covering the bracket 12;
two lower edges 16 arched downwards, opposite to the upper edge 14;
lateral edges 18, 20 connecting the upper 14 and lower 16 edges, the lateral edge 18 being provided for covering, at least partially, the mast 8;
two advertising medium faces 22, 24 each exhibiting a pattern, this pattern featuring a line 26 arched downwards extending the ends of the upper edge 14.

The curvature radii of the bracket 12, of the upper edge 14 of the sail 6 and of the pattern featuring the line 26, are identical.

The sail 6 delimits between the advertising medium faces 24, 26 an open volume within which the frame 4 is engaged in the way of a sock.

The sail 6 is made of a material flexible enough to perfectly fit the shape of the frame 4, and opaque enough to hide the frame 4 engaged within the sail 6. For example, the sail 6 can be made in a polyester mesh.

The device 2 comprises means for stretching the sail 6 on the frame 4. The means for stretching the sail comprise a pin 28 mounted on the mast 8, extending transversely to the mast 8.

The means for stretching the sail 6 also comprise a strap 30 linked to the sail 6 likely to be attached to the pin 28. This strap 30 has two strap portions 30a, 30b fixed to the sail 6 and the free ends of which are equipped with complementary fixing means, such as pieces of hook and loop fabrics.

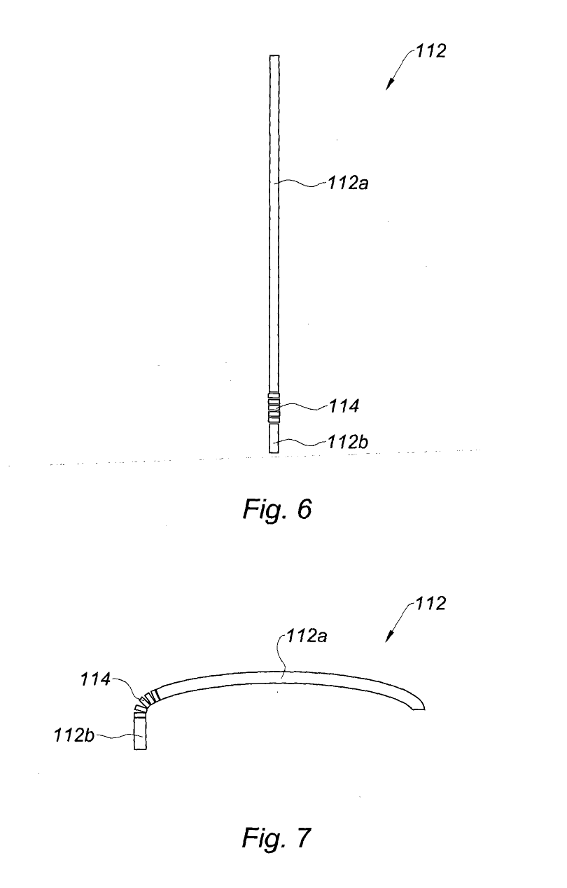

FIGS. 6 and 7 represent a bracket 112 identical to the bracket 12 except that it comprises articulation means connecting bracket segments 112a, 112b, and allowing a deformation of the bracket 112 between:
a non-use position (represented in FIG. 6) in which the bracket segments 112a, 112b extend in a substantially parallel manner; and
a use position (represented in FIG. 7) in which the bracket segments 112a, 112b extend in a substantially perpendicular manner.

The articulation means comprise a ball joint 114 connecting the bracket segments 112a, 112b.

For example, the ball joint 114 may include:
a plurality of rings of plastic material, for example of polycarbonate;
two tubes forming tips for joining to the bracket segments 112a and 112b;
an element of elastomeric material inserted into the plurality of rings and into the two tubes. For example, the bracket segments 112a, 112b may be made of polycarbonate. The ball joint 114 can be made of an elastomeric material.

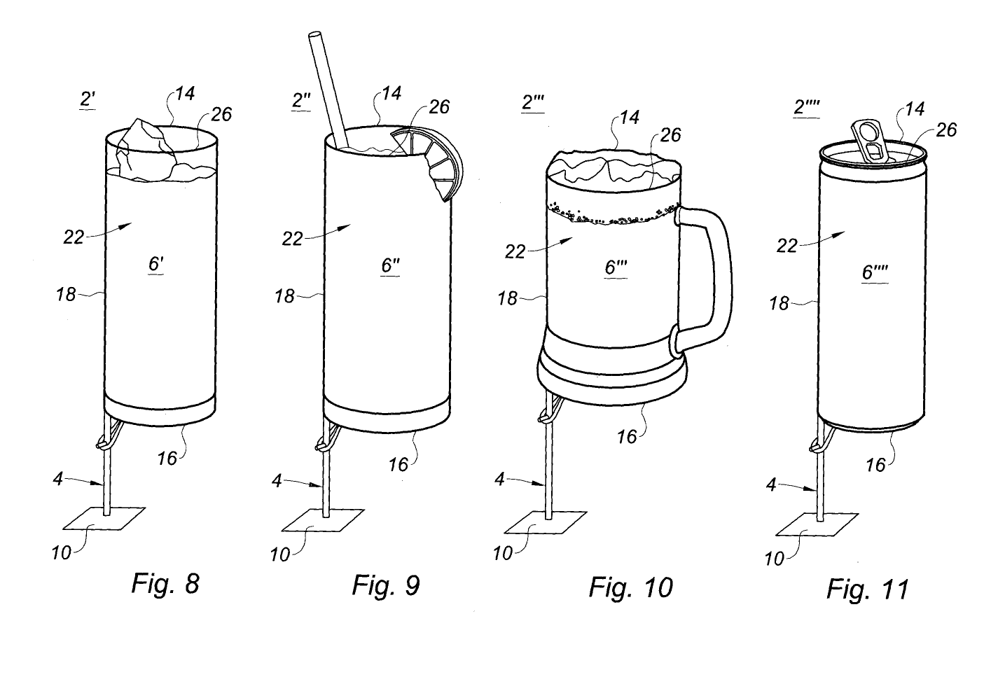

FIG. 8 represents a device 2′ identical to the device 2 except that the sail 6 is replaced by a sail 6′. The sail 6′ delimits the outline of a glass containing an ice cube, the glass and the ice cube being viewed in perspective.

FIG. 9 represents a device 2″ identical to the device 2 except that the sail 6 is replaced by a sail 6″. The sail 6″ delimits the outline of a glass onto which a slice of lemon is fixed, the glass and the lemon being viewed in perspective. An element is fitted on the sail to feature a straw viewed in perspective.

FIG. 10 represents a device 2″′ identical to the device 2 except that the sail 6 is replaced by a sail 6″′. The sail 6″′ delimits the outline of a beer mug from which foam is overflowing, the mug and the foam being viewed in perspective. An element is fitted on the sail to feature a handle viewed in perspective.

FIG. 11 shows a device 2″″ identical to the device 2 except that the sail 6 is replaced by a sail 6″″. The sail 6″″ delimits the outline of a can, the cap of which is open, the can and the cap being viewed in perspective.

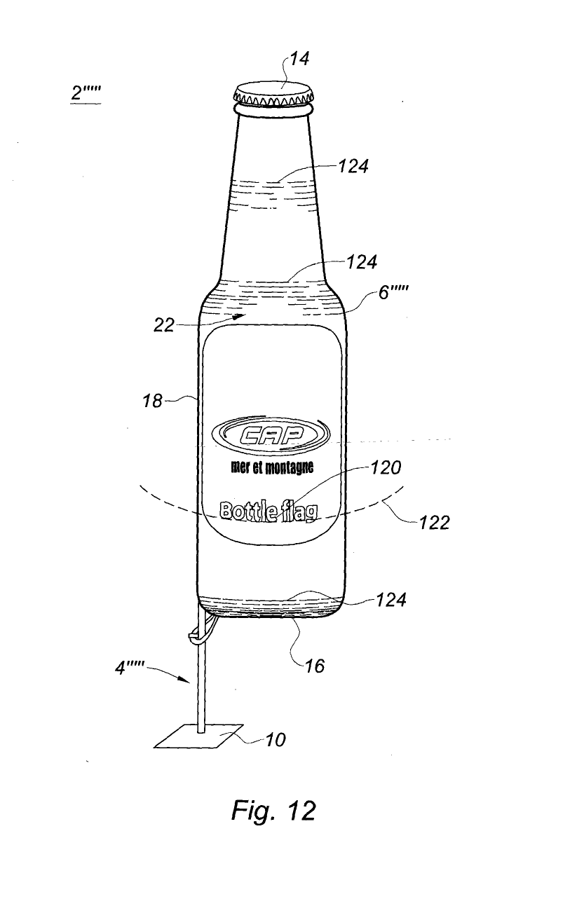

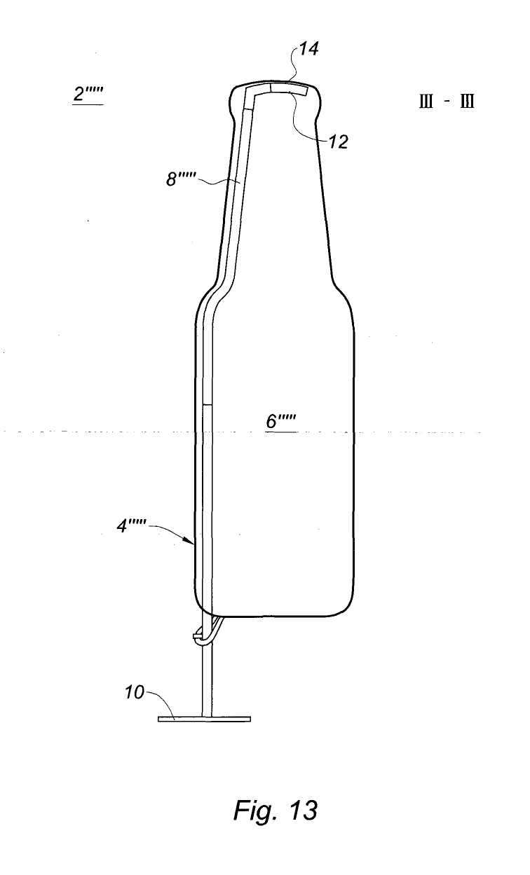

FIGS. 12 and 13 represent a device 2″″′ identical to the device 2 except that the sail 6 is replaced by a sail 6″″′. The sail 6″″″ delimits the outline of a bottle, the bottle being viewed in perspective.

The advertising medium face 22 of the sail 6″″′ exhibits a string of characters 120, for example the brand “Bottle Flag”, extending along a guiding line 122. The guiding line 122 is arched downwards following the same curvature as the lower edge 16 of the sail 6″″′. The characters of the string of characters 120 are dimensioned such that the size of the characters decreases going from the center of the string of characters 120 toward the ends of the string of characters 120. Furthermore, the advertising medium face 22 exhibits areas 124 arched downwards featuring shades.

Finally, the frame 4 is replaced by a frame 4″″′ in which the mast 8″″′ exhibits a recess so as to fit the shape of the neck of the bottle.

It goes without saying that the invention is not limited to the sole embodiments of the advertising medium device described above by way of example, it encompasses on the contrary all alternative embodiments.

Alternatively, the mast 8 can comprise only a single segment. Also alternatively, the mast 8 can be telescopic.

1. An advertising medium device for the representation of a substantially cylindrical object, such as a can, a tin or a bottle, wherein it includes:
a frame comprising a mast and a bracket at least partially arched upwards mounted on the mast; and
a sail adapted to be engaged on the frame, the sail comprising:
an upper edge at least partially arched upwards provided for covering the bracket;
at least one lower edge arched downwards, opposite to the upper edge;
first and second lateral edges connecting the upper and lower edges, the first lateral edge being provided for covering the mast; and
at least one advertising medium face exhibiting a pattern, this pattern featuring a line at least partially arched downwards extending the ends of the upper edge or a line at least partially arched upwards extending the ends of the lower edge.

2. The device according to claim 1, wherein the bracket is removably mounted on the mast.

3. The device according to claim 2, wherein the mast and/or the bracket are tubular, and the mast and the bracket are press-fitted together.

4. The device according to claim 1, wherein the bracket comprises articulation means connecting first and second bracket segments, allowing a deformation of the bracket between:
a non-use position in which the bracket segments extend substantially in a parallel manner; and
a use position in which the bracket portions extend substantially in a perpendicular manner.

5. The device according to claim 4, wherein the articulation means comprise a ball joint connecting the first and second bracket segments.

6. The device according to claim 1, wherein the sail forms a cover exhibiting:
an upper edge arched upwards provided for covering the bracket;
two lower edges arched downwards, opposite to the upper edge;
first and second lateral edges connecting the upper and lower edges, the first lateral edge being provided for covering the mast;
two advertising medium faces, at least one of which exhibits a pattern, this pattern featuring a line at least partially arched downwards extending the ends of the upper edge, or a line at least partially arched upwards extending the ends of one of the lower edges; and
and in that the sail delimits between the advertising medium faces an open volume within which the frame can be engaged.

7. The device according to claim 1, further comprising means for stretching the sail on the frame.

8. The device according to claim 7, wherein the means for stretching the sail on the frame comprise:
a pin mounted on the mast, extending transversely to the mast; and
a strap linked to the sail likely to be attached to the pin.

9. The device according to claim 1, wherein the strap exhibits two strap portions fixed to the sail and the free ends of which are equipped with complementary fixing means.

10. The device according to claim 1, further comprising an element fitted on the sail or on the bracket, featuring an accessory for the substantially cylindrical object.

11. The device according to claim 1, further comprising a string of characters, for example a brand, extending along a guiding line This guiding line being arched downwards or upwards.

12. The device according to claim 11, wherein the characters of the string of characters are dimensioned in such a way that the size of the characters decreases going from the center of the string of characters toward the ends of the string of characters.

13. The device according to claim 1, wherein said at least one advertising medium face exhibits at least one area arched upwards or downwards featuring a shade.

14. The device according to claim 1, wherein the mast exhibits a recess so as to fit the shape of a bottle or a can neck.

15. A method for manufacturing an advertising medium device for the representation of a substantially cylindrical object, such as a can, a tin or a bottle, the method comprising:
providing a frame comprising a mast and a bracket at least partially arched upwards adapted to be mounted on the mast;
providing a sail adapted to be engaged on the frame, the sail comprising:
an upper edge at least partially arched upwards provided for covering the bracket;
at least one lower edge at least partially arched downwards, opposite to the upper edge;
first and second lateral edges connecting the upper and lower edges, the first lateral edge being provided for covering the mast; and
at least one advertising medium face;
carrying out, on said at least one advertising medium face, a pattern featuring a line at least partially arched downwards extending the ends of the upper edge, or a line at least partially arched upwards extending the ends of the lower edges.
